(19) United States
(12) Patent Application Publication
(10) Pub. No.: US 2024/0204558 A1
(43) Pub. Date: Jun. 20, 2024

(54) REPLACEMENT OF LEAD BATTERIES WITH LITHIUM BATTERIES

(71) Applicant: SAGEMCOM ENERGY & TELECOM SAS, BOIS-COLOMBES (FR)

(72) Inventor: Tareq ALNEJAILI, BOIS-COLOMBES (FR)

(21) Appl. No.: 18/542,250

(22) Filed: Dec. 15, 2023

(30) Foreign Application Priority Data
Dec. 15, 2022 (FR) FR2213471

(51) Int. Cl. H02J 7/35; H02J 7/00; H02J 7/34

(52) U.S. Cl. CPC H02J 7/35; H02J 7/0042; H02J 7/0068; H02J 7/0071; H02J 7/342; H02J 7/0029; H02J 2300/24; H02J 2310/16

(57) ABSTRACT

An electric circuit is arranged to be connected to at least one photovoltaic panel, to at least one main battery and to a charge regulator. The electric circuit includes a first power supply component arranged to, at predefined intervals, generate a first voltage from a photovoltaic energy which is produced by the at least one photovoltaic panel; a switching module arranged to, when the first power supply component generates the first voltage, be powered by said first voltage and apply, to the terminals of the at least one main battery and of the charge regulator, for a predefined duration, a power supply voltage produced from the photovoltaic energy.

The invention relates to the field of power supply devices which are connected to photovoltaic panels and which are arranged to power client systems (such as telecommunication towers).

### BACKGROUND OF THE INVENTION

In rural areas, telecommunication towers play a very important role for connecting millions of people to civil infrastructures, and for accessing digital services, and in particular health and education services.

Usually, these telecommunication towers are powered by one or more diesel generators (DG). However, DGs have a series of disadvantages for the environment. They indeed product carbon dioxide, nitrogen oxide, particles and other dangerous exhaust gases which are released into the atmosphere.

The consumption of 1L of diesel emits, on average, 2.7 kg of CO2. With respect to other energy sources, DGs are therefore a very significant pollution source. In addition, the maintenance and fuel costs can considerably increase the operating costs of DGs.

Therefore, a power supply solution has been designed to power the telecommunication towers, based on the use of solar energy as a main energy source, and a battery bank as a secondary energy source. Such a power supply solution, particularly adapted to the countries the sunshine rate of which is high, can highly improve the environmental impact of the energy system and reduce the operating costs of the system.

The batteries used as a secondary energy source are conventionally lead batteries (lead-acid). The batteries are used during the night and bad weather periods.

However, these lead batteries have a certain number of disadvantages, among which:
Depth of Discharge: the DOD of lead batteries must not exceed 50%. Beyond this point, the service life of the battery can be affected;
life cycle: lead batteries have a low life cycle, which varies between 100 and 300 charge/discharge cycles; effectiveness: lead batteries have a reduced effectiveness of 80 to 85%;
energy density: lead batteries have a low energy density.

This power supply solution is therefore not fully satisfactory.

It has therefore been decided to replace lead batteries with lithium batteries, and for example with lithium-ion batteries, in particular of the Lithium Iron Phosphate (LiFePO4) type. Indeed, these batteries have a high DOD (up to 95%), a good life cycle (1500 charge/discharge cycles, typically), a high yield (up to 95%) and a good energy density. In addition, these batteries require no maintenance nor ventilation, contrary to lead batteries.

Therefore, a power supply device is obtained, similar to that of FIG. 1.

The power supply device 1 is integrated in a cabinet 2 which is connected, on the one hand, to photovoltaic panels 3, and on the other hand, to a telecommunication tower 4. It is therefore this cabinet 2 which supplies electrical energy to the telecommunication tower 4 for its power supply.

The power supply device 1 therefore comprises batteries 5, for example of the LifePO4 type, as well as a solar charge regulator 6, for example of the MPPT (Maximum Power Point Tracking) type. The power supply device 1 also comprises first protective components 7 aiming to protect the regulator 6 against an overvoltage or a current peak coming from the photovoltaic panels 3, second protective components 8 aiming to protect the batteries 5, and third protective components 9 aiming to protect the telecommunication tower 4 against an overvoltage or a current peak coming from the power supply device 1.

Lithium batteries 5 are conventionally equipped with a Battery Management System 10 (BMS).

The BMS 10 is an electronic system responsible for monitoring, balancing, coordinating and controlling Lithium-ion battery cells. The BMS 10 manages the control in real time of each cell of the battery 5, communicates with external devices, manages the calculation of the SOC (State Of Charge), measures the temperature and the voltage, etc. For each battery 5, the BMS 10 in this case comprises a heat management module 11, a cell management module 12, and a switching module 14 comprising switching MOSFETs.

It protects the battery 5 from different defects, such as overvoltage, overcurrent, undervoltage, overheating, etc.

In case of adverse event (undervoltage, overvoltage, etc.), the BMS 10 can insulate and disconnect the cells of the battery 5 using MOSFET transistors, which are considered as interfaces between the cells of the battery 5 and the negative and positive external terminals of the battery 5.

If the switching MOSFETs of the battery 5 are disconnected under any event, a voltage must be applied to the output terminals of the battery 5 to reactivate it.

However, two major problems have been detected during the replacement of lead batteries with lithium batteries (in particular, LiFePO4).

The first problem relates to the entry into service of the power supply device 1 following the installation of new LifePO4 batteries. During the first installation, a high inrush current is demanded by the charge regulator 6 to charge its output capacitors C1 . . . CN. This peak current risks damaging the protective circuit of the BMS 10 of each battery 5, which has the consequence of damaging the battery 5, which must thus be replaced.

The second problem relates to the current operation of the power supply device 1. If one of the batteries 5 is completely discharged, the BMS 10 disconnects it and insulates it from the rest of the device 1. To reconnect the battery 5, a voltage must be applied to its input. In the absence of such a voltage, the power supply device 1 is not operational and must be manually started up to avoid an energy blackout.

To resolve the first and the second problem, a technician must intervene on the site by being provided with a small diesel generator. This solution if very difficult to implement as, in most cases, telecommunication towers and their power supply system are located in remote areas with very difficult access. The telecommunication service is therefore interrupted for a long period.

### AIM OF THE INVENTION

The invention aims, during the replacement of lead batteries with lithium batteries in a power supply device such as described above, to resolve the problems which have just been stated without using any diesel generator, and simply and inexpensively.

### SUMMARY OF THE INVENTION

In view of achieving this aim, an electric circuit is proposed, arranged to be connected to at least one photovoltaic panel, to at least one main battery and to a charge regulator, and comprising:
a first power supply component arranged to, at predefined intervals, generate a first voltage from a photovoltaic energy which is produced by the at least one photovoltaic panel;
a switching module arranged to, when the first power supply component generates the first voltage, be powered by said first voltage and apply, to the terminals of the at least one main battery and of the charge regulator, for a predefined period, a power supply voltage produced from the photovoltaic energy.

At predefined intervals, the power supply voltage is therefore automatically applied, and for a predefined duration at the input of the charge regulator and of the main batteries.

This makes it possible for the charge regulator to charge its output capacitors without demanding the main batteries to have a high peak current. When a main battery is completely discharged, the power supply voltage makes it possible for it to automatically reconnect.

The two problems stated above, occurring during the replacement of lead batteries with lithium batteries, are therefore resolved.

The proposed solution does not require any onsite intervention of an operator provided with a diesel generator, since the electric circuit uses only photovoltaic energy for its power supply.

The solution is very simple to implement, since it is sufficient to connect the electric circuit to the photovoltaic panels, to the batteries and to the charge regulator.

The electric circuit produces the power supply voltage automatically. It operates autonomously: it does not need to be controlled or powered by another circuit.

The electric circuit comprises very few components, and these components are very simple components (no microcontroller, processor, etc.), such that the electric circuit is very inexpensive.

The invention therefore greatly facilitates the introduction of lithium batteries in the applications such as described above.

In addition, an electric circuit is proposed, such as described above, the first power supply component being powered by an input voltage produced by the at least one photovoltaic panel, the first power supply component being arranged to generate the first voltage, when the input voltage is greater than a minimum threshold voltage of the first power supply component.

In addition, an electric circuit is proposed, such as described above, wherein the switching module comprises:
a second power supply component arranged to be powered by the first voltage and to produce a second voltage;
a timer relay comprising a switch and arranged to be powered by the second voltage, and to, when the second voltage moves from a zero value to a non-zero value, close the switch for the predefined duration, to apply the power supply voltage to the terminals of the at least one main battery and of the charge regulator, then reopen the switch following the predefined duration.

In addition, an electric circuit is proposed, such as described above, the power supply voltage being the first voltage.

In addition, an electric circuit is proposed, such as described above, further comprising a secondary battery and a third power supply component, the secondary battery being arranged to be charged by the first power supply component, and therefore by the photovoltaic energy, the switch of the timer relay being mounted between the secondary battery and the third power supply component, the third power supply component being arranged to be powered by a secondary voltage to the terminals of the secondary battery when the switch is closed, the third power supply component thus being arranged to produce a third voltage which is the power supply voltage.

In addition, a piece of equipment is proposed, comprising a casing and an electric circuit, such as described above, the electric circuit being positioned in the casing.

In addition, a power supply device is proposed, comprising at least one main battery, a charge regulator, and an electric circuit, such as described above.

In addition, a power supply device is proposed, such as described above, the at least one main battery being a lithium battery.

In addition, a method for replacing at least one original battery positioned in a cabinet is proposed, wherein a charge regulator is also positioned, and which is connected to at least one photovoltaic panel, comprising the steps of:
removing the at least one original battery from the cabinet;
replacing the at least one original battery with at least one main battery;
integrating the electric circuit, such as described above, in the cabinet, by connecting the electric circuit to the at least one photovoltaic panel, to the at least one main battery and to the charge regulator.

In addition, a replacement method, such as described above, is proposed, wherein the at least one original battery is a lead battery and the at least one main battery is a lithium battery.

In addition, a power supply method is proposed, implemented in the electric circuit, such as described above, and comprising the steps of:
de-energising a coil of the timer relay;
if the input voltage is greater than the minimum threshold voltage of the first power supply component, energising the coil and thus closing the switch of the timer relay;
applying the power supply voltage to the terminals of the at least one main battery and of the charge regulator;
counting the predefined duration by a time delay component;
when the time delay component has counted the predefined duration, opening the switch of the timer relay.

The invention will be best understood in the light of the description below of particular, non-limiting embodiments of the invention.

### BRIEF DESCRIPTION OF THE DRAWINGS

Reference will be made to the accompanying drawings, among which:

FIG. 1 represents a photovoltaic panel, a telecommunication tower and a power supply device of the prior art;

FIG. 2 is a figure similar to FIG. 1, with an electric circuit according to a first embodiment integrated in the power supply device;

FIG. 3 represents the electric circuit according to the first embodiment;

FIG. 4 again represents the electric circuit according to the first embodiment, connected to the photovoltaic panels, to the charge regulator and to the telecommunication tower;

FIG. 5 represents a flowchart of control of the electric circuit;

FIG. 6 represents the electric circuit according to a second embodiment.

### DETAILED DESCRIPTION OF THE INVENTION

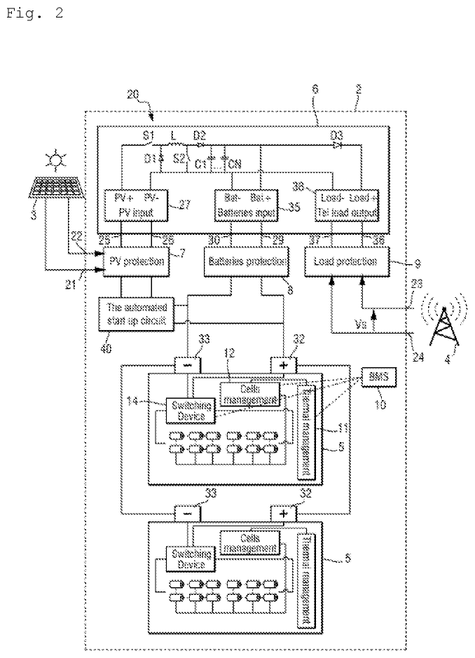

In reference to FIG. 2, the invention is, in this case, implemented in a power supply device 20.

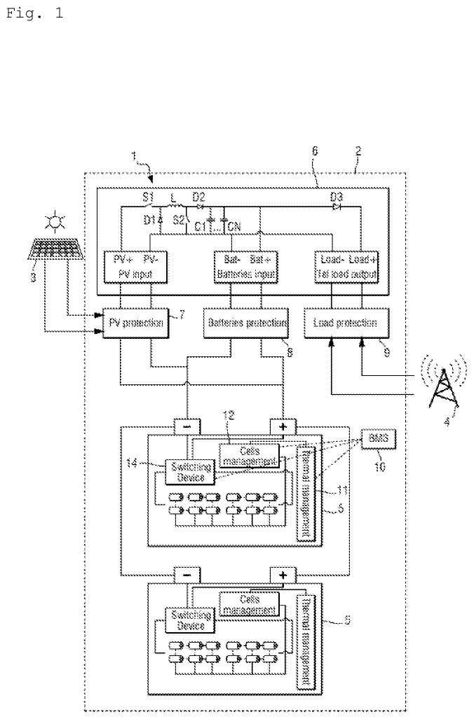

The elements of FIG. 2, which are identical to those of FIG. 1, keep their reference.

The power supply device 20 is connected to at least one photovoltaic panel 3 (in this case, to several), and to at least one client system, in this case, to a telecommunication tower 4. The power supply device 20 powers the at least one client system, i.e. in this case, the telecommunication tower 4.

The power supply device 20 integrates a charge regulator 6, in this case of the MPPT type, and at least one main battery 5 (in this case, several), which are lithium batteries, in this case, of the LiFePO4 type.

The power supply device 20 is integrated in a cabinet 2, which comprises, in this case, a first input 21, a second input 22, a first output 23 and a second output 24.

The first input 21 and the second input 22 are connected to two ports of the system formed by the photovoltaic panels 3 (which are connected to one another). The first input 21 is a positive input and the second input 22 is a negative input.

The first output 23 and the second output 24 are connected to the telecommunication tower 4. The first output 23 is a positive output and the second output 24 is a negative output. The power supply device 20 supplies an output current to the telecommunication tower 4 to power it, under an output voltage Vs applied between the first output 23 and the second output 24.

The charge regulator 6 first comprises a first input 25 and a second input 26.

The first input 21 and the second input 22 of the power supply device 20 are connected respectively, via the first protective components 7, to the first input 25 and to the second input 26 of the charge regulator 6. The first input 25 is a positive input and the second input 26 is a negative input.

The first input 25 and the second input 26 are themselves connected to a first input module 27 of the charge regulator 6, via which this therefore acquires the current produced by the photovoltaic panels 3.

The charge regulator 6 comprises, in addition, a third input 29 and a fourth input 30 which are connected, via the second protective components 8, to the terminals of the main batteries 5. The third input 29 is a positive input and the fourth input 30 is a negative input.

The third input 29 is connected, via the second protective components 8, to the positive terminal 32 of each main battery 5. The main batteries 5 are mounted in parallel: the positive terminals 32 of the batteries 5 are connected to one another, and the negative terminals 33 of the batteries 5 are connected to one another. The fourth input 30 is connected, via the second protective components 8, to the negative terminal 33 of each battery 5.

The third input 29 and the fourth input 30 are themselves connected to a second input module 35 of the charge regulator 6, via which this therefore acquires the current produced by the batteries 5.

The charge regulator 6 comprises, in addition, a first output 36 and a second output 37 which are respectively connected, via the third protective components 9, to the first output 23 and to the second output 24 of the cabinet 2. The first output 36 is a positive output and the second output 37 is a negative output.

The first output 36 and the second output 37 are themselves connected to an output module 38 of the charge regulator 6.

The charge regulator 6 comprises a first switch S1, a first diode D1, an inductance L, a second switch S2, a second diode D2, output capacitors C1 . . . CN and a third diode D3.

The first switch S1, the inductance L, the second diode D2 and the third diode D3 are mounted in series.

The first diode D1, the second switch S2 and the output capacitors C1 . . . CN are mounted parallel with one another.

The first switch S1 has a terminal connected to the first input 25 via the first input module 27. The anode of the first diode D1 is connected to the second input 26 via the first input module 27.

The terminals of the output capacitors C1 . . . CN are connected to the third input 29 and to the fourth input 30 via the second input module 35. The cathode of the third diode D3 and the negative terminals of the output capacitors are respectively connected to the first output 36 and to the second output 37 via the output module 38.

Now, the implementation of the invention is focused on.

Lithium batteries (in this case, LiFePO4) have been integrated in the power supply device, i.e. the main batteries 5, instead of lead batteries. Therefore, the two problems which have been described above exist: high inrush current demanded by the charge regulator 6 at the entry in service, and disconnection by the BMS 10 of a discharged battery 5.

To overcome these problems, an electric circuit 40 is integrated in the power supply device 20, and therefore in the cabinet 2.

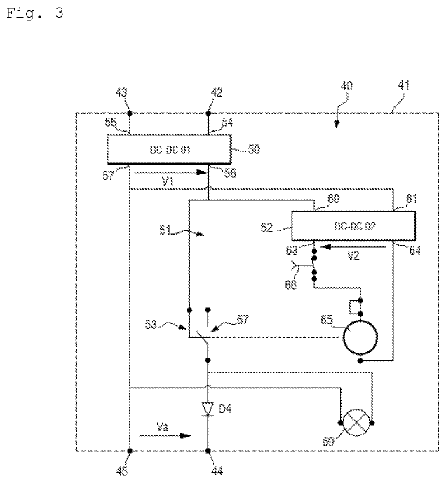

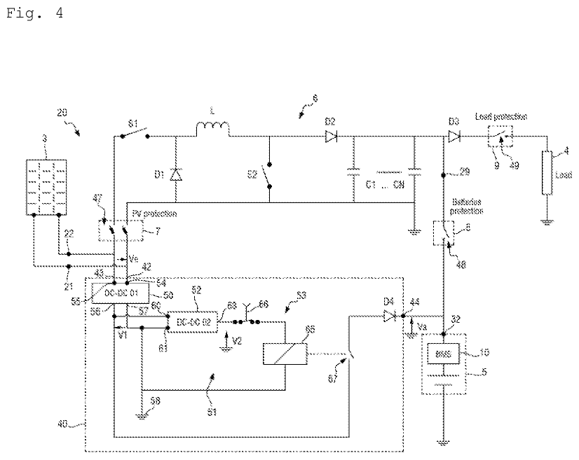

First, a first embodiment of the electric circuit is described. This first embodiment can be seen in FIGS. 3 and 4.

The electric circuit 40 is, in this case, integrated in the casing 41 of a small piece of equipment that is positioned and connected in the cabinet 2. This equipment comprises connectors making it possible to connect the electric circuit 40 to the photovoltaic panels 3 (in any case, to at least one photovoltaic panel 3), to the batteries 5 and to the charge regulator 6.

The electric circuit 40 comprises a first input 42 (positive input), a second input 43 (negative input), a first output 44 (positive output) and a second output 45 (negative output).

When the electric circuit 40 is integrated in the power supply device 20, the first input 42 is connected to the first input 21 of the cabinet 2, and the second input 43 is connected to the second input 22 of the cabinet 2. The first input 42 and the second input 43 of the electric circuit 40 are therefore connected to the photovoltaic panels 3.

It is noted in FIG. 4, that the first protective components 7 comprise fuses 47.

The first output 44 of the electric circuit 40 is connected to the positive terminal 32 of the batteries 5, and therefore, via the second protective components 8 (including a circuit breaker 48 to protect the batteries 5), to the third input 29 of the charge regulator 6. The second output 45 of the electric circuit 40 is connected to the negative terminal 33 of the batteries 5, and therefore, via the second protective components 8, to the fourth input 30 of the charge regulator 6. It is noted that the second output 45 of the electric circuit can be connected to an electric ground of the power supply device 20, which is itself connected to the negative terminals 33 of the batteries 5.

It is noted in FIG. 4, that the third protective components 9 comprise a circuit breaker 49 to protect the telecommunication tower 4.

The electric circuit 40 comprises a first power supply component 50 and a switching module 51.

The switching module 51 comprises a second power supply component 52 and a timer relay 53 (power relay).

The electric circuit 40 also comprises an output diode D4.

The first power supply component 50 and the second power supply component 52 are DC/DC converters (they produce a direct voltage from a direct voltage).

The first power supply component 50 has a first input 54 (positive input) connected to the first input 42 of the electric circuit 40, and a second input 55 (negative input) connected to the second input 43 of the electric circuit 40. The first power supply component 50 has a first output 56 (positive output) and a second output 57 (negative output). The second output 57 is connected to an electric ground 58 of the electric circuit 40 (itself connected to an electric ground of the power supply device 20).

The second power supply component 52 has a first input 60 (positive input) connected to the first output 56 of the first power supply component 50, and a second input 61 (negative input) connected to the second output 57 of the first power supply component 50 (and therefore to the electric ground 58). The second power supply component 52 has a first output 63 (positive output), and a second output 64 (negative input).

The timer relay 53 comprises a coil 65, a time delay component 66, and a switch 67.

The coil 65 comprises a first terminal connected to the first output 63 of the second power supply component 52 and a second terminal connected to the electric ground 58. The switch 67 comprises a first terminal connected to the first output 56 of the first power supply component 50 and a second terminal connected to the anode of the output diode D4.

The cathode of the output diode D4 is connected to the third input 29 of the charge regulator 6 via the second protective components 8 and to the positive terminal 32 of each battery 5 (and therefore to the BMS 10 of each battery 5).

A signal lamp 69 is connected between the second output 57 of the first power supply component 50 and the terminal of the switch 67 which is connected to the anode of the diode D4.

Now, the operation of the electric circuit 40 is described.

The first power supply component 50 is arranged to, at predefined intervals, generate a first voltage V1 from a photovoltaic energy which is produced by the photovoltaic panels 3.

The switching module 51 is arranged to, when the first power supply component 50 generates the first voltage V1, be powered by said first voltage V1 and apply, to the terminals of the main batteries 5 (terminals 32 and 33) and of the charge regulator 6 (inputs 29 and 30), for a predefined duration, a power supply voltage Va produced from the photovoltaic energy.

The input voltage Ve, produced by the photovoltaic panels 3, powers the first power supply component 50.

When the input voltage Ve at the input of the first power supply component 50 is less than the minimum threshold voltage of the first power supply component 50, the output voltage of the first power supply component is zero.

When the input voltage Ve is greater (in this case, greater than or equal to) than the minimum threshold voltage of the first power supply component 50, the first power supply component 50 produces the first voltage V1 from the photovoltaic energy produced by the photovoltaic panels 3.

The first voltage V1 is a constant and known voltage, which depends on the design of the first power supply component 50 itself.

When the first power supply component 50 produces the first voltage V1, this powers the switching module 51, and therefore the second power supply component 52.

The second power supply component 52 thus produces the second voltage V2 (which is also constant and known). The second voltage V2 powers the timer relay 53. The coil 65 of the timer relay 53 is activated and, for a predefined duration, closes the switch 67.

This predefined duration, equal for example to 30 seconds, is defined by an adjustment of the timer relay 53, which is done, for example, in the factory.

Thus, for the predefined duration, the first voltage V1, which is the power supply voltage Va, is applied both at the input of the charge regulator 6 and at the terminals of its output capacitors C1 . . . CN, but also at the input of the main batteries 5 and of the BMS's 10.

When the power supply voltage Va is applied, the signal lamp 69 is illuminated.

From the predefined duration, the coil 65 is deactivated, the switch 67 is open, and the power supply voltage Va (i.e. the first voltage V1) is no longer applied.

Thus, during the first entry in service of the power supply device 20 with the batteries 5 (lithium), the photovoltaic panels 3 power the first power supply component 50, and, consequently, the second power supply component 52 is powered, and the coil 65 of the timer relay 53 is activated.

The timer relay 53 used the available output power of the first power supply component 50 (the current circulates via the switch 67) to progressively charge the output capacitors C1 . . . CN of the charge regulator 6. In this way, the peak current, which can damage the BMS circuit 10 of the batteries 5, is removed. After having counted the “On Delay” time (i.e. the predefined duration, in this case, equal to 30 seconds), the timer relay 53 disconnects the electric circuit 40 (the switch 67 takes the OFF position, i.e. that it is open) from the rest of the power supply device 20, which can therefore be started correctly.

In the case of the second problem, if a main battery 5 is completely discharged (or several batteries 5), the electric circuit 40, automatically again, will use the photovoltaic energy available to activate the BMS 10 (as it will connect the PV panels 3 to the batteries 5 via the first power supply component 50).

Initially, the first power supply component 50 will power the coil 65 of the timer relay 53 (via the second power supply component 52), and start to charge the battery 5 during the “On Delay” time of the timer relay 53. Beyond this time lapse, the electric circuit 40 will be disconnected from the rest of the power supply device 20 (the switch 67 takes the OFF position) and the battery 5 starts to be correctly charged by the charge regulator 6. In this way, a long “Blackout” period will be avoided.

The operation of the electric circuit 40 is completely automatic. The electric circuit 40 does not require any “complex” component to control its operation (and no software). The electric circuit 40 operates autonomously. The electric circuit 40 is powered only by photovoltaic energy, which enables it to supply the power supply voltage Va, automatically, at predefined intervals and for the predefined duration, to the output capacitors C1 . . . CN and to the BMS 10 of each battery 5.

The power supply voltage Va is applied by the electric circuit 40 automatically, at predefined intervals and for the predefined duration.

The predefined intervals are therefore, in this case, daily intervals. At night, the input voltage Ve produced by the photovoltaic panels 3 is zero, and therefore less than the minimum threshold voltage of the first power supply component 50, and therefore the output voltage of the first power supply component 50 is zero. The power supply voltage Va is zero (and the switch 67 is open).

Each morning, when the input voltage Ve becomes greater than or equal to the minimum threshold voltage of the first power supply component 50, this produces the first voltage V1. The second power supply component 52 is powered and produces the second voltage V2. The coil 65 is thus activated. The power supply voltage Va, equal to the first voltage V1, is thus applied at the input of the batteries 5 and of the charge regulator 6 for the predefined duration (equal, in this case, to 30 seconds).

Following the predefined duration, the first power supply component 50 continues to produce the first voltage (until the end of the day), but the coil 65 of the timer relay 53 is deactivated, the switch 67 is open, and the electric circuit 40 is disconnected from the rest of the power supply device 20.

This operation is carried out each morning of each day, which settles both the problem of the peak current at the first operation of the power supply device 20, and also the reconnection of the main batteries 5 to the rest of the power supply device 20 when they have been completely discharged. It is noted that the predefined intervals are, in this case, daily, but can be of a different duration, as their duration depends on the time at which the input voltage Ve exceeds the predefined threshold (and therefore depends on the sunshine each morning).

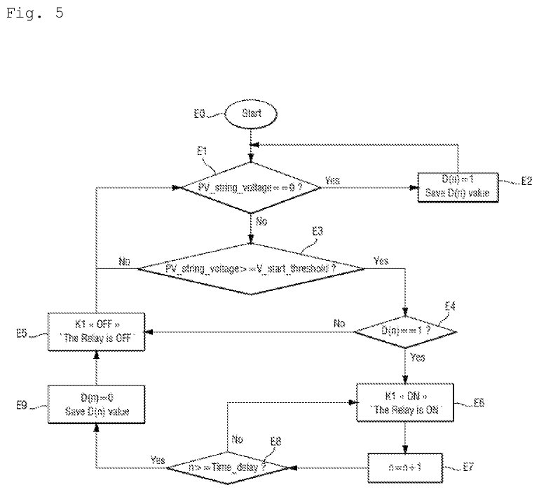

The different steps of the method are described, in reference to FIG. 5, corresponding to the automatic sequencing of the actions carried out by the electric circuit 40.

The following variables are used to describe this sequencing:
PV_string_voltage, which is the value of the input voltage Ve;
n, which represents time, i.e. the current instant;
D(n), which indicates the state of the coil 65 at the time n. D=1 indicates that the coil 65 of the relay 53 is initialised and can enter into a new counting cycle;
K1, which indicates the state of the switch 67.

The method starts with a starting step E0.

At the time n, if the input voltage (PV_string_voltage) is equal to zero (step E1), the coil 65 of the timer relay 53 is de-energised and returns to its initial state: step E2.

The value 1 is given to the variable D (n).

The method returns to step E1.

At step E1, if the input voltage is not zero, a second condition must be verified to activate the timer relay 53: the input voltage Ve must be greater (in this case, greater than or equal to) than the minimum threhsold voltage (V_start_threshold) of the first power supply component 50: step E3. As this is not the case, the method loops back to step E1 (then E3 again).

At step E3, when the input voltage Ve is greater than or equal to the minimum threshold voltage, the relay 53 can be activated, on the condition that the variable D(n) is equal to 1: step E4.

If this is not the case, the switch 67 remains in the open position (OFF state—off): step E5. The method returns to step E1.

If the variable D (n) is equal to 1, the switch 67 is closed (ON state—on): step E6.

All of the photovoltaic panels 3 starts to charge the output capacitors C1 . . . CN of the charge regulator 6 and the batteries 5 (via the first power supply component 50). The power supply device 20 can thus start correctly. The charge regulator 6 supplies the telecommunication tower 4.

The time delay component 66 starts to count the Time_delay Td, i.e. the predefined duration (equal to 30 seconds, for example). The variable n is incremented: step E7.

The method moves to step E8.

As the time n is strictly less than the predefined duration, the method loops back to step E6, the switch 67 remains closed.

When the time n becomes greater than or equal to the predefined duration, and therefore when the time delay component 66 has counted the predefined duration, the value of the variable D (n) moves to 0: step E9.

The switch 67 of the timer relay 53 opens (OFF state—off): step E5.

The method moves back to step E1.

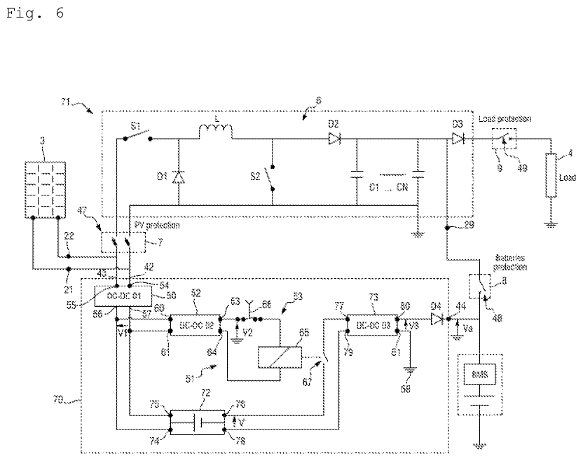

An electric circuit 70 is now described, in reference to FIG. 6, according to a second embodiment, which is integrated in a power supply device 71.

The electric circuit 70 again comprises a first power supply component 50, a switching module 51 comprising a second power supply component 52 and a timer relay 53, and an output diode D4.

The electric circuit 70 in addition comprises a secondary battery 72 and a third power supply component 73 which is a DC/DC converter.

The first power supply component 50 has a first input 54 (positive input) connected to the first input 42 of the electric circuit 70, and a second input 55 (negative input) connected to the second input 43 of the electric circuit 70. The first power supply component 50 has a first output 56 (positive output) and a second output 57 (negative output).

The second power supply component 52 has a first input 60 (positive input) connected to the first output 56 of the first power supply component 50, and a second input 61 (negative input) connected to the second output 57 of the first power supply component 50. The second power supply component 52 has a first output 63 (positive output), and a second output 64 (negative input).

The timer relay 53 comprises a coil 65, a time delay component 66, and a switch 67.

The coil 65 comprises a first terminal connected to the first output 63 of the second power supply component 52 and a second terminal connected to the second output 64 of the second power supply component 52.

The secondary battery 72 comprises a first input terminal 74 (positive) connected to the first output 56 of the first power supply component 50 and a second input terminal 75 (negative) connected to the second output 57 of the first power supply component 50.

The secondary battery 72 comprises a first output terminal 76 (positive) connected to a first terminal of the switch 67. The second terminal of the switch 67 is connected to a first input 77 (positive) of the third power supply component 73.

The secondary battery 72 comprises a second output terminal 78 (negative) connected to a second input terminal 79 of the third power supply component 72.

The third power supply component 73 comprises a first output 80 (positive) connected to the anode of the diode of the output D4, and a second output 81 (negative) connected to the electric ground 58.

The cathode of the output diode D4 is connected to the first output 44 of the electric circuit 70, and therefore to the third input 29 of the charge regulator 6 via the second protective components 8 and to the positive terminal 32 of each battery 5 (and therefore to the BMS 10 of each battery 5).

Again, the electric circuit 70 is powered by the input voltage Ve produced by the photovoltaic panels 3.

The first power supply component 50, at predefined intervals, generates the first voltage V1 from the photovoltaic energy which is produced by the photovoltaic panels 3. When the first power supply component 50 generates the first voltage V1, the switching module is powered by the first voltage V1 and applies, to the terminals of the main batteries 5 (terminals 32 and 33) and of the charge regulator 6 (inputs 29 and 30), for the predefined duration, a power supply voltage Va produced from the photovoltaic energy.

The first power supply component 50 generates the first voltage V1 when the input voltage Ve is greater than (or equal to) the minimum threshold voltage of the first power supply component 50. The first voltage powers the second power supply component 52. The coil 65 is activated and the switch 67 is on for the predefined duration.

The automatic operation of the electric circuit 70 is therefore sequenced in the same way as the electric circuit 40.

However, this time, the power supply voltage Va is not the first voltage V1 produced by the first power supply component 50.

The power supply voltage Va is a third voltage V3 (constant and known) produced by the third power supply component 73 when this is powered by a secondary voltage V′ at the terminals of the secondary battery 72.

The secondary battery 72 is charged by the first power supply component 50, and therefore by the photovoltaic energy, when the first power supply component 50 produces the first voltage V1, i.e. when the input voltage Ve is greater than or equal to the minimum threshold voltage of the first power supply component 50.

The secondary voltage V′ powers the third power supply component 73 when the switch 67 is closed (ON state—on).

This solution is advantageous for the following reason. The secondary battery 72 is recharged continuously by the photovoltaic panels 3 (when sunshine is sufficient such that the input voltage Ve is greater than or equal to the minimum threshold voltage), and therefore permanently contains a certain quantity of energy.

It is thus ensured, in the morning, when the switch 67 is closed for the predefined duration, and when it is not very sunny during the day, that the quantity of energy that can supply the electric circuit 70 is sufficient to charge the output capacitors C1 . . . CN of the charge regulator 6 and to activate the BMS 10.

The way in which at least one original battery (in this case, several) is/are replaced by at least one main battery 5 (in this case, several), in an existing cabinet 2 which is already connected to the photovoltaic panels 3 and to the telecommunication tower 4 is now described.

The original batteries as well as a charge regulator 6 are positioned in the cabinet 2.

The original batteries are lead batteries.

The new batteries (main batteries 5) are lithium batteries.

First, the original batteries are removed from the cabinet 2.

Then, the original batteries are replaced with the main batteries 5.

Then, the equipment comprising the electric circuit 40, 70 is integrated in the cabinet, and therefore the electric circuit 40, 70, by connecting the electric circuit to the photovoltaic panels 3, to the main batteries 5 and to the charge regulator 6.

The power supply device can thus normally start and power the telecommunication tower 4.

Thus, an operation of the power supply device is ensured, without encountering the problems stated above.

Naturally, the electric circuit could also be integrated in the power supply device from its manufacture.

Naturally, the invention is not limited to the embodiments described, but includes any variant entering into the field of the invention such as defined by the claims.

In this case, it is indicated that the power supply device is intended to power a telecommunication tower but, more generally, it is intended to power at least one of any client system. This could be one or more of any electric installations, and for example, a clinic, one or more dwellings, etc.

The embodiments described in this case are not at all limiting.

In particular, the switching module could be different from that described, in this case. Thus, a switch and a counter could be had, which counts the predefined duration and which actuates the switch (instead of an “integrated” relay). The second power supply component is not compulsory.

The power supply voltage could be produced differently and, for example, in the first embodiment, by a fourth power supply component powered by the first power supply component.

1. An electric circuit arranged to be connected to at least one photovoltaic panel, to at least one main battery and to a charge regulator, and comprising:
a first power supply component arranged to, at predefined intervals, generate a first voltage from a photovoltaic energy which is produced by the at least one photovoltaic panel;
a switching module arranged to, when the first power supply component generates the first voltage, be powered by said first voltage and apply, to the terminals of the at least one main battery and of the charge regulator, for a predefined duration, a power supply voltage produced from the photovoltaic energy.

2. The electric circuit according to claim 1, the first power supply component being powered by an input voltage produced by the at least one photovoltaic panel, the first power supply component being arranged to generate the first voltage when the input voltage is greater than a minimum threshold voltage of the first power supply component.

3. The electric circuit according to claim 1, wherein the switching module comprises:
a second power supply component arranged to be powered by the first voltage and to produce a second voltage;
a timer relay comprising a switch and arranged to be powered by the second voltage and to, when the second voltage moves from a zero value to a non-zero value, close the switch for the predefined duration to apply the power supply voltage at the terminals of the at least one main battery and of the charge regulator, then reopen the switch following the predefined duration.

4. The electric circuit according to claim 3, the power supply voltage being the first voltage.

5. The electric circuit according to claim 3, further comprising a secondary battery and a third power supply component, the secondary battery being arranged to be charged by the first power supply component and therefore by the photovoltaic energy, the switch of the timer relay being mounted between the secondary battery and the third power supply component, the third power supply component being arranged to be powered by a secondary voltage at the terminals of the secondary battery when the switch is closed, the third power supply component thus being arranged to produce a third voltage which is the power supply voltage.

6. An equipment comprising a casing and an electric circuit according to claim 1, the electric circuit being positioned in the casing.

7. A power supply device comprising at least one main battery, a charge regulator, and an electric circuit according to claim 1.

8. The power supply device according to claim 7, wherein the at least one main battery is a lithium battery.

9. A method for replacing at least one original battery positioned in a cabinet, wherein a charge regulator is also positioned, and which is connected to at least one photovoltaic panel, comprising the steps of:
removing the at least one original battery from the cabinet;
replacing the at least one original battery with at least one main battery;
integrating the electric circuit according to claim 1 in the cabinet, by connecting the electric circuit to the at least one photovoltaic panel, to the at least one main battery and to the charge regulator.

10. The method according to claim 9, wherein the at least one original battery is a lead battery and the at least one main battery is a lithium battery.

11. A power supply method, implemented in the electric circuit according to claim 2, wherein the switching module comprises:
a second power supply component arranged to be powered by the first voltage and to produce a second voltage;
a timer relay comprising a switch and arranged to be powered by the second voltage and to, when the second voltage moves from a zero value to a non-zero value, close the switch for the predefined duration to apply the power supply voltage at the terminals of the at least one main battery and of the charge regulator, then reopen the switch following the predefined duration, the method comprising the steps of:
de-energising a coil of the timer relay;
if the input voltage is greater than the minimum threshold voltage of the first power supply component, energising the coil and thus closing the switch of the timer relay;
applying the power supply voltage to the terminals of the at least one main battery and of the charge regulator;
counting the predefined duration by a time delay component;
when the time delay component has counted the predefined duration, opening the switch of the timer relay.
